(19) United States
(12) Patent Application Publication
(10) Pub. No.: US 2009/0157612 A1
(43) Pub. Date: Jun. 18, 2009

(54) USER-CREATED SEARCH RESULTS IN AN INCENTIVE SCHEME

(75) Inventors: Phillip T. Su, Kirkland, WA (US); Eric Burns, Seattle, WA (US); Hugh E. Williams, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/956,957

(22) Filed: Dec. 14, 2007

(51) Int. Cl. G06F 17/30

(52) U.S. Cl. 707/3; 707/E17.108

(57) ABSTRACT

An economy is created where users compete to get their search lists shown based on a set of criteria. The search lists can be displayed after the users pay a rent associated with a query. The search lists continue to be displayed if search lists are popular with the public. If a search list is popular, it earns revenue for the creator of the list. If the search list is not popular, it is removed from being displayed and receives no further consideration. The creator initially creates a search list for a low-valued query and moves up to creating a search list for a higher-valued query if the creator can pay the higher rent associated with the higher-valued query. The creator earns more revenue when targeting higher-valued queries. The creator continues to create search lists until the highest-valued queries are reached.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Today, search engines have two key challenges. Algorithmic search engines continue to fall short of completeness, relevance, and results-ordering when compared with expert human judgments. Algorithmic search engines include those like LIVE SEARCH from Microsoft Corporation of Redmond, Wash., and GOOGLE from Google Incorporated of Mountain View, Calif. “Open-source” or community-based search engines do not have critical mass momentum due to the size of the search space and the lack of participation incentives. Community-based search engines include those like WIKIA from Wikia Incorporated of San Mateo, Calif.

### SUMMARY

The present invention is defined by the claims below. Embodiments of the present invention solve at least the above problems by providing a system and media for, among other things, providing access to user-created search results when creating search engine results based on a search term, providing an incentive for users to create good search result lists, and developing good user-created search results.

User-created search results are stored at servers to be displayed to users desiring search results from a search query. When a search term is received, search engine results are displayed along with a set of links that connect to a set of user-created search results. A link can only be displayed if the creator of the search result has paid a fee. The creator can earn revenues if the search result proves to be popular with the public. The popularity of the search result can be determined based on volume access and user satisfaction. As the user-created search result becomes more popular, it earns more revenue. If the user-created search result becomes less popular, it is removed from being displayed. The creator begins by creating search results for a low-valued query. As the creator earns revenues, the creator can pay higher fees thereby targeting higher-valued queries and creating search results for the higher-valued queries.

In another aspect, the popularity of the search result created by the creator can be compared to the search engine results. If the search result is more popular than the search engine results, it continues to be displayed and gets further consideration.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram of an exemplary operating environment suitable for practicing an embodiment of the present invention;

FIG. 2 is an exemplary screenshot in an exemplary operating environment illustrating machine-generated search results and links to user-created search results;

FIG. 3 is an exemplary screenshot in an exemplary operating environment illustrating user-created search results;

FIG. 4 is a flowchart of an exemplary process for providing access to user-created search results;

FIG. 5 is a flowchart of an exemplary process for providing an incentive for users to create good search results; and

FIG. 6 is a flowchart of an exemplary process for developing good user-created search results.

### DETAILED DESCRIPTION

Embodiments of the present invention provide a system and media for providing access to user-created search results and for providing an incentive to create good user-created search results.

### Acronyms and Shorthand Notations

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention. The following is a list of these acronyms:

| | |
|---|---|
| CD | Compact Disc |
| CD-ROM | Compact Disc-Read-Only Memory |
| DVD | Digital Versatile Discs |
| EEPROM | Electrically Erasable Programmable Read-only |
| | Memory |
| RAM | Random Access Memory |
| ROM | Read-Only Memory |

Further, various technical terms are used throughout this description. A definition of such terms can be found in Newton's Telecom Dictionary by H. Newton, 23^{rd} Edition (2007). These definitions are intended to provide a clearer understanding of the ideas disclosed herein but are not intended to limit the scope of the present invention. The definitions and terms should be interpreted broadly and liberally to the extent allowed the meaning of the words offered in the above-cited reference.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

### User-Created Search Results

Embodiments of the present invention enable users to create and curate lists of web links targeting specific queries. These lists can be shown alongside search results generated by search applications. The more popular lists can earn revenue for the creators which creates a market economy that rewards constructive behavior. As the creators earn revenues with their good lists, the creators can then create and curate more lists targeting different or more valuable queries. In this context, a creator is a user that creates and curates lists of web links, such as search results, targeting specific queries.

In order to fuel the economy between creating lists from queries and generating revenues for creators, ad revenues from ads that are shown on websites are used to pay the creators. However, ads are not the only mechanism that may be used to generate revenues. Revenues from a subscription or usage could also be used depending on how the present invention is implemented. The economy provides flexibility by allowing creators to generate popular lists and allowing creators to invest in new entrants into the economy.

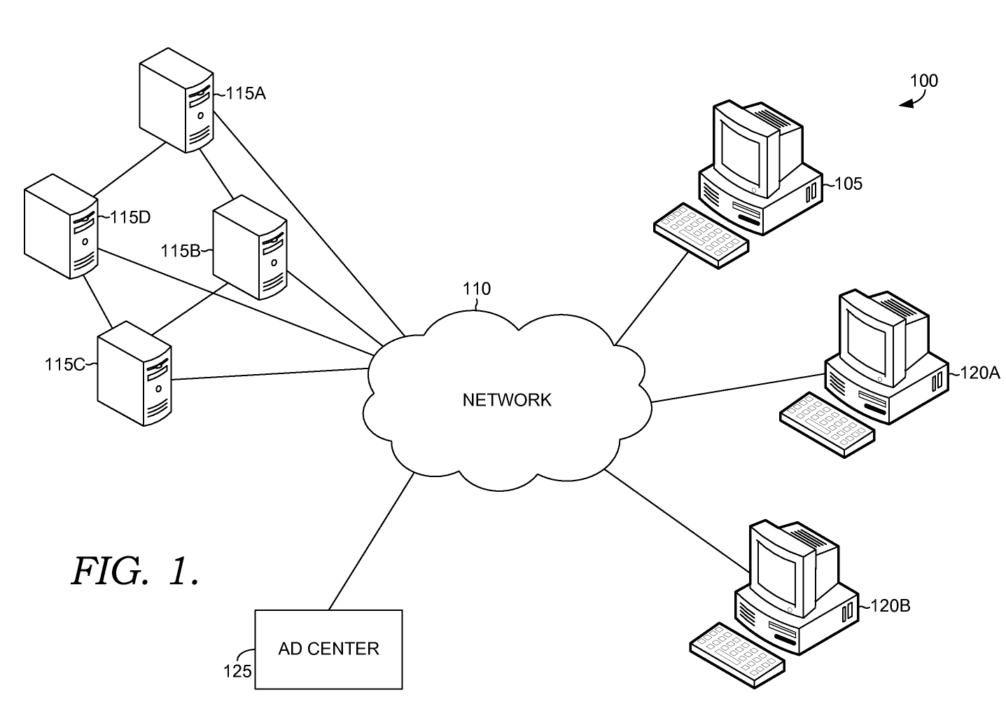

In FIG. 1, a creator 105, servers 115A, 115B, 115C, and 115D (115A-D), users 120A and 120B, and ad center 125 can communicate with each other through a network 110 in environment 100. Creator 105 represents a user operating a computing device such as a computer or a laptop. At creator 105, a user can create lists of web links such as search results based on a search query. Servers 115A-D represent computing devices that have a plurality of functions. Servers 115A-D can operate a search application or have access to the search application or a search engine. Servers 115A-D can also provide web pages to display information.

Like creator 105, users 120A and 120B represent users operating computing devices such as a computer or a laptop. Users 120A and 120B can access services over network 110 such as the Internet. Ad center 125 represents a business for handling advertisements that appear on websites. An example of ad center 125 can be ADCENTER® by Microsoft Corporation of Redmond, Wash.

With an implementation of an embodiment of the present invention, any user can create a list targeting any query. The user, at creator 105, creates a list of search results for a specific query and sends the list to servers 115A-D. Servers 115A-D represent the servers that might be involved in the implementation of the embodiments of the present invention. In some implementations, the actual number of servers may be more or less. In addition, the functions on each server may vary and the actual number of servers may be influenced by a desire for redundancy or for segregation of responsibilities. For example, server 115A might contain a search engine while search 115B might handle the inputs and outputs related to the handling of web pages. Server 115C might store information related to the lists created by creator 105. Server 115D may operate a business model that oversees all the processes for implementing the economy discussed above. The idea here is to convey that the implementations for servers 115A-D are exemplary and are shown to represent various functions.

Ad center 125 implements a business model related to advertising. One of ordinary skill in the art is familiar with the plethora of ads that appear over the Internet in various web pages. Many business models exist that allow advertisers to pay monies to have their ads shown on particular websites. Some of the computer programs behind the advertising systems are sophisticated enough that a particular ad with a particular subject may be shown based on the content in the web page. This setup has proven to be very popular with advertisers desiring to target specific consumers. For example, if a user provides a search query to a search engine, the user can expect to get back a set of search results. In addition, the user may see a set of advertisements shown on the same web page related to the search query or the search results. Somewhere behind the scene with servers 115A-D and ad center 125, an advertiser paid monies to have their ad shown during this time. The idea here is to provide a brief synopsis of how an exemplary economy is created that will be discussed more fully later. It is not provided to discuss the details of how the advertising system fully works.

Users 120A and 120B represent persons that access network 110 such as the Internet. Users 120A and 120 may input search terms into a search engine at a web interface shown at their computing devices. For example, users 120A and 120B may desire to input search queries into a search engine such as LIVE SEARCH from Microsoft Corporation of Redmond, Wash. When the search query or queries are provided to the search application, a number of search results are returned in the form of a list of links. Users 120A and 120B have the option of selecting one or more of the links based on desirability. One of ordinary skill in the art is familiar with search engines and how they work. The search results are listed in the web page in various formats. Sometimes, the search results span multiple pages.

In an implementation of an embodiment, a scenario may described as to how the present invention may be used. A user, such as creator 105 can create a list targeting a query. The list is sent to servers 115A-D or a subset thereof to be shown to the public whenever the list is accessed. However, a link to the list is shown to the public when creator 105 pays a value or rent. The amount that creator 105 pays depends on the query, which has an assigned value. Regardless of the size of the generated list, creator 105 pays the value or rent commensurate with the assigned value to the query. Higher value queries command higher payments or rents.

Continuing with the scenario, creators can earn income if their lists are popular meaning that users access their lists through the links or use their lists. As a list becomes more popular, it earns more income for its creator. In an implementation of an embodiment of the present invention, the popularity of a list can be determined in a number of ways. In one exemplary way, the popularity can be based on a volume access. The number of times a link to a list is accessed can be tracked and monitored. In another exemplary way, the popularity can be based on user satisfaction. In an embodiment, user interaction can be monitored to capture what a user selects in a display. If the user clicks on a link and selects an item on the list of results, this information can be monitored and captured. If a selection is made, the selection can be recorded as to what the user desired to access. In another embodiment, user interaction can be captured as a dwell time. The system can measure how long the user stays at a particular web page after an item on the list is selected. In yet another exemplary way, a combination of the volume and user satisfaction can be used to determine popularity.

Various implementations can be used to determine popularity for various embodiments of the present invention. The exemplary ways described above are not limiting and may include others not discussed here.

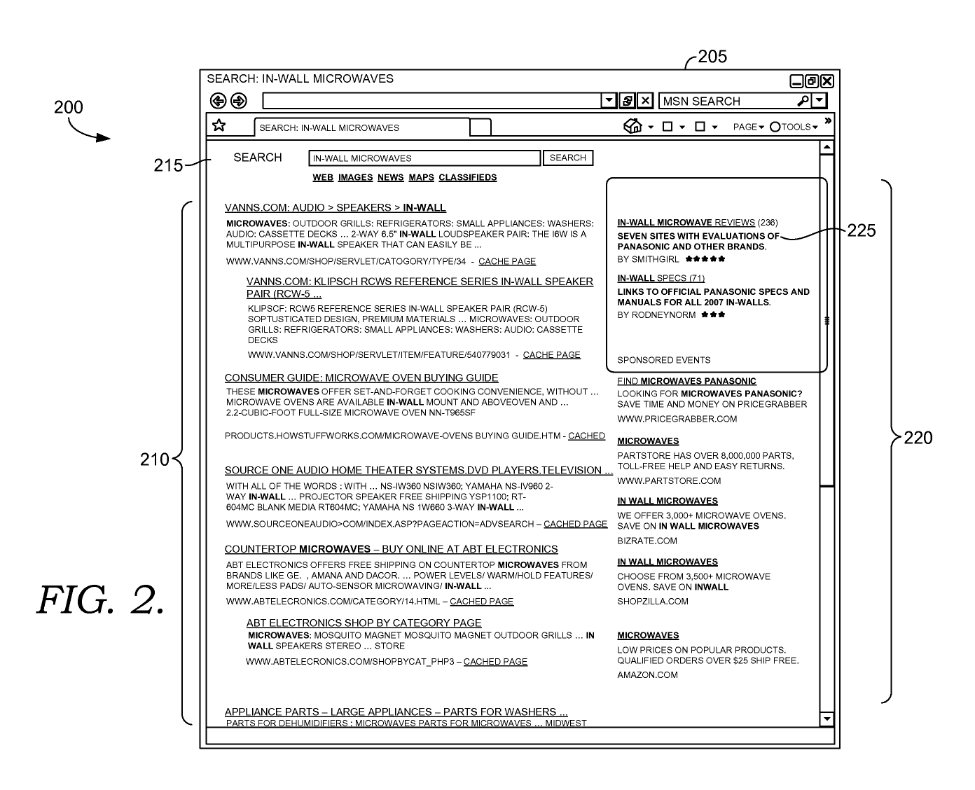

As embodiments of the present invention describe incentives for creator 105 to generate a good list, embodiments of the present invention deter the creation of bad lists. If a list is not popular, it will not earn income. Over time, a bad list will lose its opportunity to be shown to the public in favor of more popular lists. This can occur even if the creator has initially paid a value or rent to be shown. For one thing, there is only a limited amount of space where a link can be shown on a web page. It is highly competitive to get a list to be shown and to keep the list being shown. The incentive is to create a good list that will be popular in order to keep it in the public view for as long as possible. FIG. 2 describes visually how creators can get their lists in front of the public.

Turning now to FIG. 2, a screenshot 205 is shown in an exemplary first display 200. Screenshot 205 illustrates the results that are displayed from operating environment 100. Screenshot 205 shows a displayed web page with a machine-generated search results 210, a link to a search engine 215, user-created links 220, and a top-rated link 225. Screenshot 205 can be created when users 120A and 120B access search engine 215 at a web page. A query such as “microwaves” may be entered as input into search engine 215. When the user clicks the search button, the results appear as shown in screenshot 205. Machine-generated search results 210 are shown from the query “microwaves”. User-created links 220 are shown in response to the same query.

Although the details are not shown, over time, the user-created links 220 may appear differently than shown in screenshot 205 even with the same query. As the popularity of the links changes, the position of the links changes. The more popular lists will get their links shown first. Hence, at a snapshot in time, top-rated link 225 is the most popular link (to the most popular search result) and is shown in a first position. As long as top-rated link 225 remains the most popular list, it can be located in the first position. Less popular links or lists will ultimately be removed from consideration. However, in another implementation of an embodiment, top-rated link 225 may share its top display spot with other links. If the number of user-created lists are numerous, a mechanism has to be employed that can insure that all lists are shown to the public. Lists may be selected for display in a “round-robin” fashion or selected on a random basis. Even at the top positions, several lists may prove to be so popular that it is only fair to show each list in the top spot. The links to these lists may also be shown on a rotated basis.

One can understand that the idea of the present invention is to provide user-created search results that are better than machine-generated search results 210. In FIG. 2, if users 120A and 120B do not like machine-generated search results 210, they can select one of the links in user-created links 220 to find search results that are more desirable or in more conformity with the search query. Hence, the popularity of the user-created search results can help determine good search results.

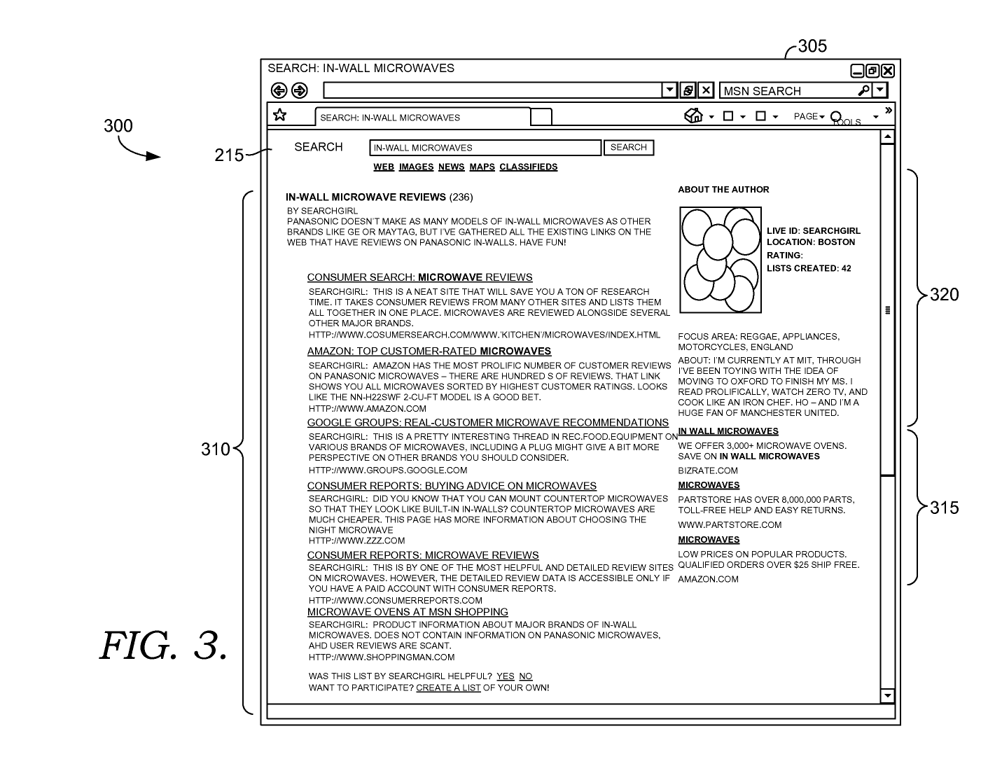

In FIG. 3, a screenshot 305 is shown in a second display 300. Screenshot 305 illustrates the results that are displayed in the web page when users 120A and 12B select top-rated link 225 in FIG. 2. Top-rated link 225 expands into a user-created search results 310. User-created search results 310 are a listing of web links associated with the search query. By design, user-created search results 310 look similar to machine-generated search results 210. It becomes a matter of desirability whether users 120A and 120B prefer machine-generated search results 210, user-created search results 310, or some other search result listing.

Continuing with FIG. 3, links 315 are also shown in screenshot 305 along with an ad 320. Links 315 can be links to other user-created search results. So, if the user does not like user-created search results 310, the user can select another link for another set of search results.

Ad 320 illustrates an exemplary aspect of an implementation of an embodiment. Ad 320 can be shown in various positions in screenshot 305 or not shown at all. Ad 320 can also be shown in screenshot 205 or not shown at all. An implementer can determine how ads are used in order to fuel the economy of generating revenues to pay creators for good search result lists. However, it is also understood that an implementer does not need to use advertisements to establish an economic situation and may implement embodiments of the present invention without the use of ads. For example, an economy can be implemented in a non-montary scheme such as using “reputation points” where the motive to participate in the economy is based on obtaining kudos or recognition.

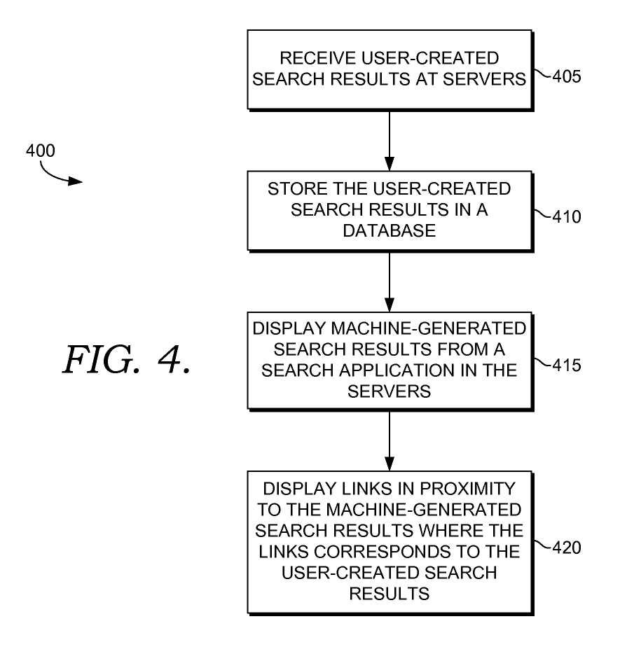

Turning now to FIG. 4, a process for providing access to user-created search results is shown in a method 400. In a step 405, user-created search results are received at servers 115A-D from creator 105. The user-created search results include a list of web links that pertain to a search query. In a step 410, the user-created search results are stored in a database. The database can be at servers 115A-D or located elsewhere. Typically, thousands of creators can generate thousand or perhaps millions of user-created search results which will be managed at servers 115A-D. In a step 415, machine-generated search results 210 are displayed from a search application in or associated with servers 115A-D. When user 120A or 120B provides a search query to the search application, machine-generated search results 210 are displayed. In a step 420, user-created links 220 are displayed next to machine-generated search results 210. Each link of user-created links 220 corresponds to each listing of user-created search results. When a user selects a link, a listing of search results appears in the display.

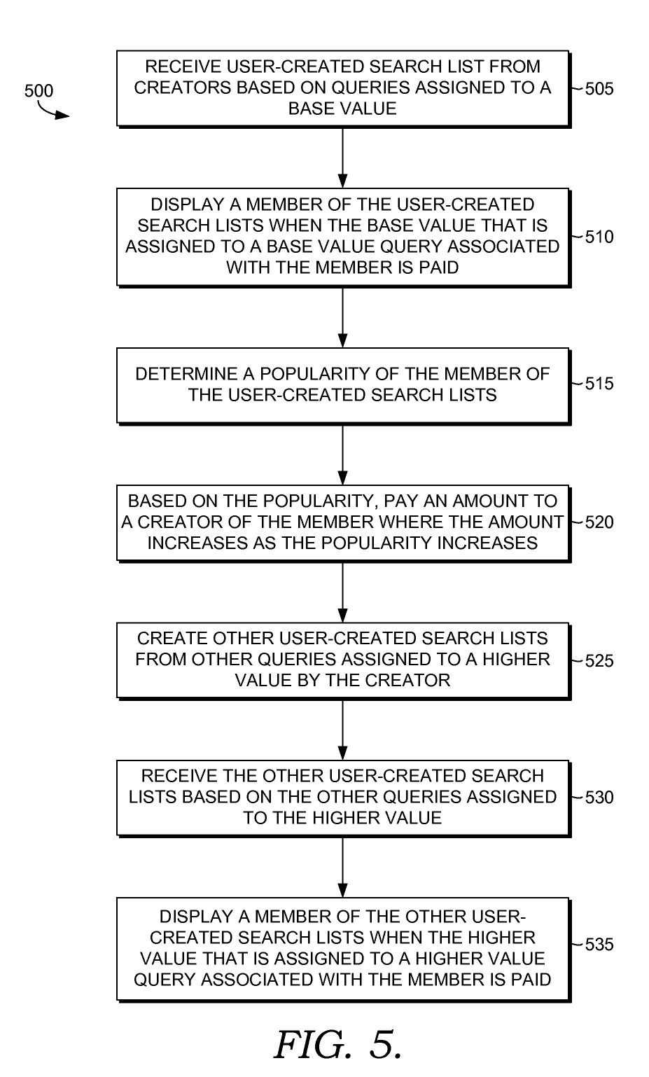

In FIG. 5, a process for providing an incentive for users to create good search results is shown in a method 500. In a step 505, user-created search lists from creators like creator 105 are received at servers 115A-D based on queries that are assigned a base value. In a step 510, a member of the user-created search lists is displayed when the base value is paid. The base value is assigned to a query associated with the member. The base value is established by an implementer and typically includes a monetary amount. In an implementation of an embodiment of the present invention, various search queries are assigned different values or rents. A creator starts out creating search queries that have the lowest base value. Initially, the creator only has a minimum amount available to pay the rent to have the search list displayed for the lowest valued queries. Therefore, the creator can only target low-valued queries to create search lists since the creator cannot afford to pay the rent yet for higher-valued queries.

In a step 515, a popularity of the member of the user-created search lists is determined. As discussed above, the popularity can be based on a volume access of how many users click on the links for the user-created search lists. The popularity can be based on user satisfaction such as determining what a user selects, measuring how long the user stays at a web page, measuring how often the particular user accesses the web page, or measuring another variable not listed here. The popularity can be based on a combination of both the volume access and user satisfaction. The idea here is to convey that different embodiments may implement popularity in a number of ways and the descriptions here are exemplary and not limiting.

In a step 520, an amount that is based on the popularity is paid to a creator of the member where the amount increases as the popularity increases. In an embodiment, if users like the search results of a particular creator, that creator earns revenue. The most popular search results earn the best revenues. However, it must be noted that an implementer may fix or restrict the amount of revenue that is earned based on a number of factors such as how often users access the search results, how often users submit a query associated with the search results, whether the query is low-valued or high-valued, whether the user spends a significant time at a user-created search result versus the machine-generated search result, etc. The idea here is to convey that the creator can earn enough revenues to target and create more high-valued queries which in theory should provide higher revenues if the search result listing is good and popular.

In a step 525, other user-created search lists are created by the creator from other queries that are assigned to a higher value. At this point, the creator has earned revenues from the search result lists associated with lower-valued queries. Now, the creator progresses to creating search results for higher-valued queries. In a step 530, the creator provides the other user-created search lists to servers 115A-D just like the initial search lists. In a step 535, a member of the other user-created search lists are displayed when the creator pays the higher-valued rent for the higher-valued query.

As discussed above, one can see the economy that is created which allows the creator to progress up levels in creating higher-valued search lists. This process is cyclical and the creator can continue to progress to earn higher revenues as long as the search lists are good and popular to the public. As the creator earns revenues for a search list associated with a query at a particular value level, the creator can move to the next level of queries of higher value and create search lists in that level.

The flip side of any progress made by the creator is that a search list may not earn any revenue. Or, the search list may become stagnant. If this happens, the search list will eventually be removed from being displayed. As discussed above, embodiments of the present invention provide incentives to create good search results. Therefore, many creators will attempt to create the best search results possible for a particular query. As a result, a search result that is popular today may not be popular in the future. Since, over time, creators will continue to improve their search results for the particular query. Hopefully, users will gravitate to the most popular search results. This competition should fuel a behavior for creating good search results and deter a behavior for creating bad search results. It should also deter destructive behavior such as spamming or gaming.

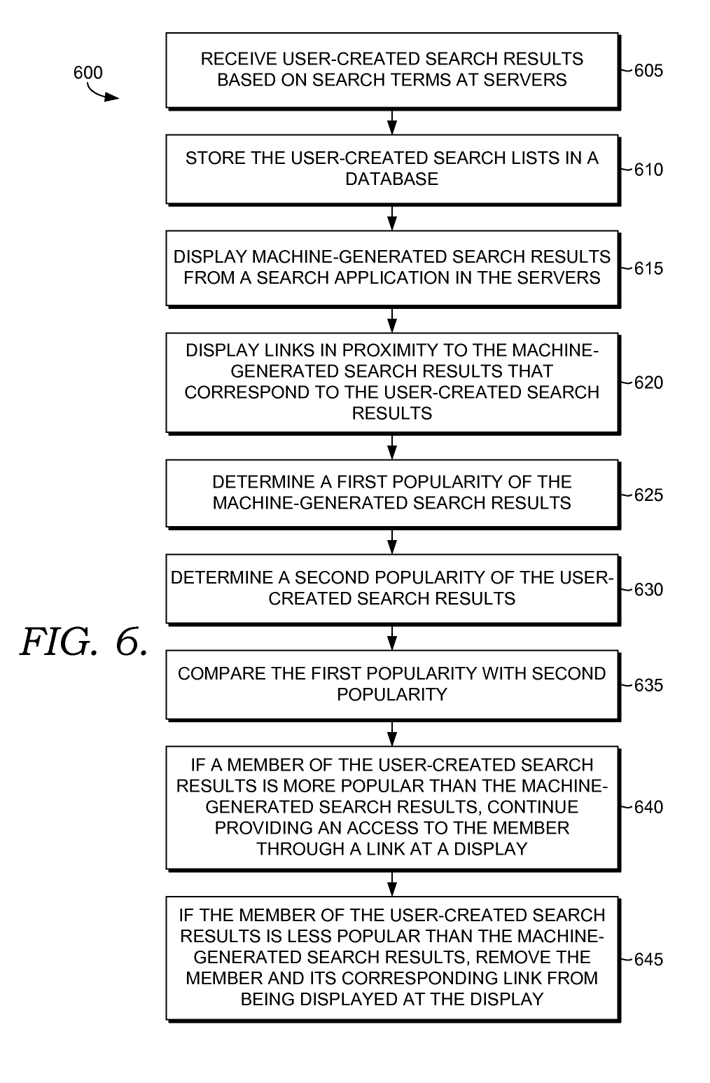

Turning now to FIG. 6, a process for developing good user-created search results is shown in a method 600. Steps 605-620 are similar to steps 405-420 and shall not be repeated here. In a step 625, a first popularity of machine-generated search results 210 is determined. In a step 630, a second popularity of user-created search results 310 is determined. In a step 635, the first popularity and second popularity are compared to determine which search results are more popular. As discussed above, various mechanisms can be implemented to determine popularity in an effort to indicate good search results without obtaining a reading of false positives. An implementer has to consider various factors in determining how popularity will be calculated without making the process overly burdensome. For example, the implementer may implement a combination of determining volume access and user satisfaction to determine popularity. One reason for this implementation would be to deter an unscrupulous creator from submitting a search list and then accessing the search list numerous times. The implementer could monitor how often the creator (now the user) accesses the search list to remove false readings.

In a step 640, if a member of the user-created search results 310 is more popular than machine-generated search results 210, a link to the member will continue to be displayed. Or, the link will be considered a top-rated link that can be displayed at or near the top position in the web page. In a step 645, if the member of the user-created search results 310 is less popular than machine-generated search results 210, the link and the contents are removed from being displayed. As stated above, an embodiment of the present invention should provide an incentive to foster creating good search results.

In order to deter destructive behavior in the economy of providing revenues for creating search results, the implementer has to determine a plan to allow new creators to enter the economy. In an implementation of an embodiment of the present invention, newcomers can come to the economy with no revenue. A newcomer (new creator) can create a search list for a low-valued query but cannot immediately have that search list displayed. The new creator does not have initial funds in their account to pay the rent to have the search list displayed. A bootstrapping procedure has to be implemented that allows the new creator to enter the business model. One example for allowing the new creator to enter the economy is to allow other already established creators to pay the initial rent for the new creator. For example, the new creator creates a search result for a low-valued query. The new creator sends the search result to servers 115A-D where the search result is pooled with other search results from other creators. At servers 115A-D, other creators can view the new creator's search result although the search result cannot be publicly displayed. A creator, like creator 105, can choose to pay the initial rent for the new creator, especially if creator 105 likes the search result. At this point, the search result can be displayed but not immediately placed in the top position. Hopefully, over time, the search result becomes popular with users, like users 120A and 120B. As the popularity increases, revenues will be paid to the new creator. However, since creator 105 paid the first rent for the new creator, creator 105 also earns revenue in a revenue sharing scheme with the new creator.

Going back further, one may want to know how the entire economy can be started if an established creator has to pay the rent for any newcomers to the economy. One exemplary answer is that an implementer can start the process of creating lists and encouraging new creators to create lists. The implementer can pay the rent of new creators to get them started while also providing some search lists to generate competition. There is no fear of the implementer creating destructive lists or desiring to create bad lists since the implementer's purpose is to get the economy started and operating in a self-regulating system.

The prior discussion is only for illustrative purposes to convey exemplary embodiments. The steps discussed in FIGS. 4-6 may be executed without regards to order. Some steps may be omitted and some steps may be executed at a different time than shown. For example, step 420 may be executed before step 415. Step 630 may be executed before step 625. The point here is to convey that the figures are merely exemplary for the embodiments of the present invention and that other embodiments may be implemented for the present invention.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media having stored thereon computer-useable instructions for performing a method for providing access to user-created search results when creating search engine results based on a search term, comprising:
receiving at one or more servers, one or more user-created lists of search results based on one or more search terms;
storing the one or more user-created lists of search results in one or more storage devices;
displaying a machine-generated list of search results when the one or more search terms are received by a search application wherein the search application is located in the one or more servers and is accessible by a user through a web interface and an Internet connection; and
displaying one or more links in proximity to the machine-generated list of search results wherein the one or more links correspond respectively to the one or more user-created lists of search results.

2. The media of claim 1, further comprising displaying a user-created list of the one or more user-created lists of search results when the user selects a member of the one or more links.

3. The media of claim 2, wherein the one or more user-created lists of search results are one or more manually-created search results related to the one or more search terms.

4. The media of claim 1, wherein the one or more storage devices are selected from a group including a database and a memory.

5. The media of claim 1, wherein the search application is selected from a group including a search engine.

6. The media of claim 1, wherein displaying the one or more links comprises displaying a subset of the one or more links wherein the subset is selected for display based on at least one of a user satisfaction and a dwell time at a web page.

7. The media of claim 6, wherein the user satisfaction is based on monitoring what a user selects in the display.

8. The media of claim 6, wherein the dwell time is based on measuring how long a user stays at the web page.

9. A computer system having a processor and a memory for executing a method of providing an incentive for users to create good search result lists, comprising:
receiving at one or more servers from one or more creators one or more user-created search lists based on one or more queries assigned to a base value;
displaying a member of the one or more user-created search lists when the base value that is assigned to a base value query associated with the member is paid;
determining a popularity of the member of the one or more user-created search lists;
based on the popularity, paying an amount to a creator of the member of the one or more user-created search lists wherein the amount increases as the popularity increases; and
receiving one or more other user-created search lists based on one or more other queries assigned to a higher value wherein the creator creates the one or more other user-created search lists from the one or more other queries assigned to the higher value and wherein another member of the one or more other user-created search lists is displayed when the higher value that is assigned to a higher value query associated with the another member is paid.

10. The system of claim 9, wherein the popularity is associated with an access volume of the member of the one or more user-created search lists.

11. The system of claim 9, wherein the popularity is associated with a user satisfaction of the member of the one or more user-created search lists.

12. The system of claim 11, wherein the user satisfaction is based on a user selecting the member of the one or more user-created search lists through a web interface and over an Internet connection.

13. The system of claim 11, wherein the user satisfaction is based on how long a user stays at a web page.

14. The system of claim 9, wherein the base value, the higher value, and the amount, are selected from a group including monies and credits.

15. The system of claim 9, further comprising removing the member from being displayed when the popularity decreases below more popular members of the one or more user-created search lists.

16. One or more computer-readable storage media having stored thereon computer-useable instructions for performing a method for developing good user-created search results, comprising:
receiving at one or more servers, one or more user-created lists of search results based on one or more search terms;
storing the one or more user-created lists of search results in one or more storage devices;
displaying a machine-generated list of search results when the one or more search terms are received by a search application wherein the search application is located in the one or more servers and is accessible by a user through a web interface and an Internet connection;
displaying one or more links in proximity to the machine-generated list of search results wherein the one or more links correspond respectively to the one or more user-created lists of search results;
determining a first popularity of the machine-generated list;
determining a second popularity of the one or more user-created lists that correspond to the one or more links;
comparing the first popularity of the machine-generated list to the second popularity of the one or more user-created lists;
if a member of the one or more user-created lists is more popular than the machine-generated list, continuing to provide an access to the member through a link at a display wherein the access is continuous or periodic;
if the member of the one or more user-created lists is less popular than the machine-generated list, removing the member and its corresponding link from being displayed at the display.

17. The media of claim 16, wherein the popularity is associated with an access volume of the member of the one or more user-created search lists.

18. The media of claim 16, wherein the popularity is associated with a user satisfaction of the member of the one or more user-created search lists.

19. The media of claim 18, wherein the user satisfaction is based on a user selecting the member of the one or more user-created search lists through a web interface and over an Internet connection.

20. The media of claim 18, wherein the user satisfaction is based on how long a user stays at a web page.
